(19) United States
(12) Patent Application Publication
(10) Pub. No.: US 2019/0173868 A1
(43) Pub. Date: Jun. 6, 2019

(54) Image Password Entry and Use for Wireless Network Access

(71) Applicant: Microsoft Technology Licensing, LLC, Redmond, WA (US)

(72) Inventor: Amer A. Hassan, Kirkland, WA (US)

(73) Assignee: Microsoft Technology Licensing, LLC, Redmond, WA (US)

(21) Appl. No.: 15/833,948

(22) Filed: Dec. 6, 2017

(51) Int. Cl. H04L 29/06; H04W 12/06; G06F 17/30; G06K 9/62

(52) U.S. Cl. CPC H04L 63/083; H04W 12/06; H04W 84/12; G06K 9/6203; G06F 17/30247

(57) ABSTRACT

Methods and apparatus for controlling access to a network using a temporary image password are disclosed. In an implementation, a first image password may be configured as a network password. A display associated with the first image password may also be provided so the display is visible to a camera of a device. A second image password may be received at the network, where the second image password comprises a photo image of the display taken with the camera on the device accessing the network. The first and second image passwords may be compared, and, if the first image password and the second image password match, access to the network may be granted to the device. The display of the first password may comprise a display of the first image password itself, or comprise a display of a subject of the first image password.

### BACKGROUND

Advancements in wireless technology have resulted in a large number of organizations that each have their own private wireless networks. These private wireless networks may be used for accessing the organization's computer networks, or used to access the internet. For example, most businesses currently have a private wireless local area network (WLAN) that allows employees and visitors using wireless devices on the premises of the business to access the business's computer network through the WLAN, or utilize the WLAN to access the internet. When a visitor having a wireless device desires to use a business's WLAN, a visitor password comprising a number of characters is provided to the visitor for use during the time period in which the visitor is on the premises. The visitor then enters the password characters into their wireless device and logs on to the WLAN.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

The embodiments of the disclosure include systems, methods, and apparatus that utilize image passwords to control access to networks. In an implementation, an apparatus that utilizes an image password to control access to a network may be implemented in the infrastructure of the network. In operation, the apparatus may be implemented to configure a first image password to be used as a password to access the network. When a device attempts to access the network, the apparatus may receive a second image password from the device. The second image password may comprise a photo image of a display associated with the first image password, where the photo image is an image taken with a camera on the device. Upon receiving the second image password, the apparatus may determine if the first image password and the second image password match. If the first image password and the second image password match, the apparatus may grant the device access to the network. In an example, the first image password may be generated by the apparatus. In this case, the second image password received from the device may comprise a photo image of the first image password as displayed on a display screen. In another example, the apparatus may receive a photo image of a subject from a source, such as a network manager, and configure the received photo image as the first image password. In this case, the second image password received from the device may comprise a photo image of the subject that is pictured in the first image password. In an implementation, the apparatus may be configured in an access point of the network. In another implementation, the apparatus may be configured in a server that is associated with the network.

In another implementation, a method comprises configuring a first image password to be used as a network password, and providing a display associated with the first image password at a display point. The display associated with the first image password may be provided so that the display is viewable by the user of a device. The user of the device may then take a photo image of the display with a camera of the device when the user desires access to the network. The method may further include receiving a second image password at the network from the device, where the second image password comprises a photo image of the display associated with the first image password, comparing the first image password and the second image password, and, if the first image password and the second image password match, granting the device access to the network. In an example implementation, the display associated with the first image password may comprise a display of the first image password itself. For example, the display associated with the first image password may be a display of the first image password as an image on a display screen. In this case the display is provided in a manner that allows a user of a device to take a photo image of the first image password that is displayed on the display screen. In another example, the first image password may comprise a photo image of a subject, and the display associated with the first image password may be a display comprising a physical presentation of the subject that is pictured in the first image password. For example, the display may be a physical presentation of an actual object or person that is pictured in the first image password. In this case the display is provided in a manner that allows a user of a device to take a photo image of the subject that is pictured in the first image password. A user desiring access to the network may take a photo image of the subject and the photo image may be used as the password (second image password) for accessing the network.

In a further implementation, a device for accessing a network is provided. The device may be configured with a camera that allows a user of the device to capture a photo image of a display associated an image password. The device may be further configured with a network access application that allows the user to generate an image password from the photo image of the display and utilize the image password to access the network.

### BRIEF DESCRIPTION OF THE DRAWINGS

FIGS. 1A, 1B, and 1C illustrate a scenario in which an apparatus according to an implementation of the disclosure is used to provide access to a network;

FIG. 2 is a diagram illustrating portions of an example access point and example device;

FIG. 3A is a flow diagram illustrating operations performed by an example access controller implemented according to FIG. 2;

FIG. 3B is a flow diagram illustrating operations performed by an example device implemented according to FIG. 2;

FIGS. 4A, 4B, and 4C illustrate a scenario in which an apparatus according to another implementation of the disclosure is used to provide access to a network;

FIG. 5 is a diagram illustrating portions of another example access point and example device;

FIG. 6A is a flow diagram illustrating operations performed in a network access process that uses an access controller implemented according to FIG. 5.

FIG. 6B is a flow diagram illustrating operations performed by another example device implemented according to FIG. 5;

FIG. 7A is a simplified block diagram showing an example device; and,

FIG. 7B is a simplified block diagram showing an example access point.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

Implementations of the embodiments allow the owner/manager of a network to control access to the network through use of an image password. The implementations provide a useful and convenient way to provide users of devices access to the network. Access to the image password may be given to a user of a device in a manner that allows the user to easily receive and configure the image password on their devices in order to access the network. The image password may be temporary and may be changed as needed, or as desired by the owner/manager of the network. The image password may comprise any type of image data, or data that represents an image. This includes image data that may be generated by a camera device, or image data that may be displayed as an image on any type of display device. The implementations enhance network security by requiring that the user of a device be located in a particular location in order to take a photo image of a display of the image password, and configure the image password on the device. Because an image is used as the password instead of standard characters, network access break-in techniques using brute force character generation or password character guessing will not be successful. The disclosed implementations have application to any type of computer/communications network in which a password is used at a device to obtain access to the network. This may include, for example, a wireless network such as a wireless local area network (WLAN), a cellular network, or another type of wireless network. Also, in other applications, the implementations may be utilized to provide access to a business/organization network that comprises a website, or web based functions, of the organization or business.

An example implementation has application for use in a wireless local area network (WLAN) that is managed by a business or organization, where selected visitors are allowed to use the WLAN when the selected visitors are located on the premises of the business or organization. In this type of situation, the manager of the WLAN may make a display associated with a current image password of the WLAN securely available and visible to the selected visitors on the premises. For example, the display associated with the current image password may be a display of the current image password on a display screen, and the display screen may be made viewable only by the selected visitors when in a secure location. In another example, the display associated with the current image password may be a display including a physical presentation of the actual subject that is pictured in the current image password. When on the premises of the business or organization, the selected visitors may use the camera of their wireless devices to take a photo image of the display associated with the current image password. The selected visitors may then use the photo image to generate an image password at the wireless device, and use the image password to access the network. The manager of the WLAN may change the image password and the display device associated with the image password as needed and/or as desired. For example, the image password may be changed on a daily basis.

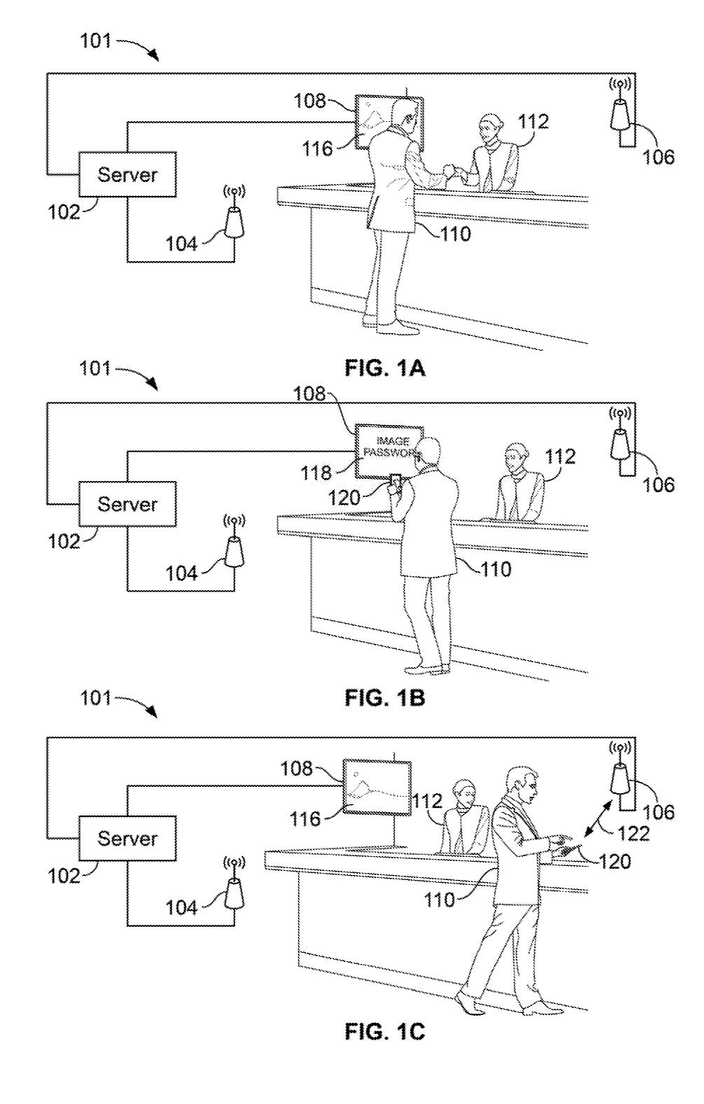

FIGS. 1A, 1B, and 1C illustrate a scenario in which an apparatus according to an implementation of the disclosure is used to provide access to a WLAN. FIGS. 1A, 1B, and 1C show the premises of an organization that operates an example WLAN 101 as a sequence of events take place over time. WLAN 101 may be implemented using server 102, access point 104, and access point 106. Access point 104 and access point 106 may provide wireless connectivity to wireless devices that operate according to one or more of the IEEE 802.11 Wi-Fi standards (Wi-Fi). Users of Wi-Fi capable wireless devices located on the premises may connect to the internet or to server 102 through access point 104 or access point 106. Server 102 may be configured to provide functions of the organization's computer network. FIGS. 1A, 1B, and 1C also show display monitor 108, which may be, for example, a wall mounted high definition television (HDTV) mounted behind a service counter managed by network manager 112 who assists visitor 110. In an example implementation, the organization may be any type of organization or business that provides services, including internet access to employees or to customers who visit the premises. For example, the business may be a coffee shop, a restaurant, or a retail facility. In other implementations, the organization may be a corporation, a school or a public/governmental agency.

WLAN 101 may include an apparatus configured as an access controller that controls the infrastructure of WLAN 101 to allow visitors, such as visitor 110, to use image passwords to access WLAN 101. The access controller may be configured in access point 106. In this case, the access controller in access point 106 may provide network access to wireless devices attempting to access WLAN 101 through access point 106, and also include a function that communicates with access point 104 to provide network access to wireless devices attempting to access WLAN 101 through access point 104. In another example implementation, the access controller may be implemented in server 102. In this case, server 102 may include functions that communicate with access point 104 and access point 106 to provide network access to wireless devices attempting to access WLAN 101 at access point 104 and access point 106.

FIGS. 1A, 1B, and 1C illustrate an example scenario for the process of accessing WLAN 101 at the visitor/employee level.

In the example of FIG. 1A, when visitor 110 arrives on the premises, visitor 110 may converse with manager 112 and ask for access to WLAN 101. At this time, general TV and/or advertisements 116 may be shown on display monitor 108.

Next, as shown in the example of FIG. 1B, in order to allow visitor 110 to access WLAN 101, manager 112 may control display monitor 108 to display the current image password 118 on display monitor 108. Visitor 110 may then be directed to take a photo image of the display with the camera of wireless device 120.

Next, as shown in the example of FIG. 1C, visitor 110 may use the photo image taken in FIG. 1B as the current image password to access WLAN 101 over channel 122 using wireless device 120. Manager 112 may also control display monitor 108 so that the display of the current image password 118 is again replaced with the display of general TV and/or advertisements 116, so that the image password 118 is no longer visible. The photo image may be input as the image password directly to a logon interface/network access application at wireless device 120 and sent to the access controller of WLAN 101 on wireless channel 122. The access controller may then validate the photo image that was sent by wireless device 120 as the current image password using image analysis to compare the photo image with the current image password. If the photo image and current image password match, the access controller may grant wireless device 120 access to WLAN 101.

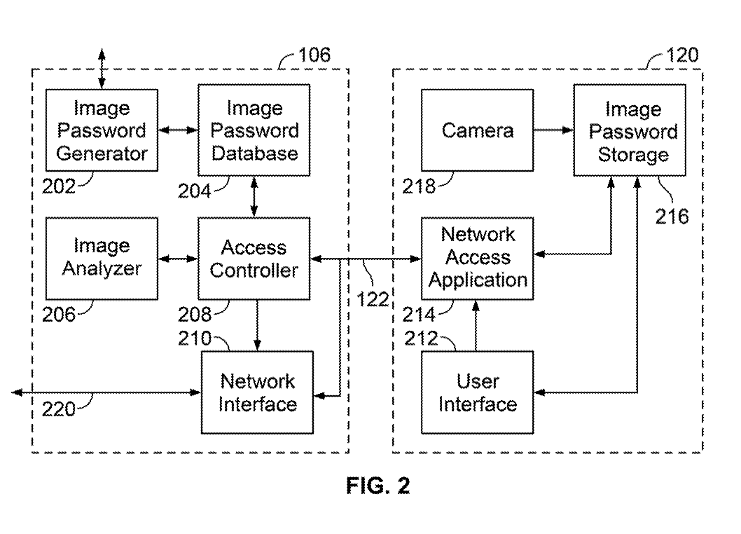

FIG. 2 is a diagram illustrating portions of an example access point and example device. Wireless device 120 of FIG. 2 represents an example implementation of wireless device 120 of FIGS. 1A-1C, and access point 106 of FIG. 2 represents an example implementation of access point 106 of FIGS. 1A-1C.

Access point 106 includes image password generator 202, image analyzer 206, image password database 204, access controller 208, and network interface 210. Wireless device 120 includes camera 218, image password storage 216, user interface 212, and network access application 214. Access point 106 and wireless device 120 may communicate over wireless channel 122 which may be a Wi-Fi channel. Network interface 210 may connect access point 106 to server 102 through communication line 220. The portions of access point 106 and wireless device 120 that are shown in FIG. 2 may be implemented in hardware including any type of processors and/or circuitry, in software, or in a combination of hardware and software.

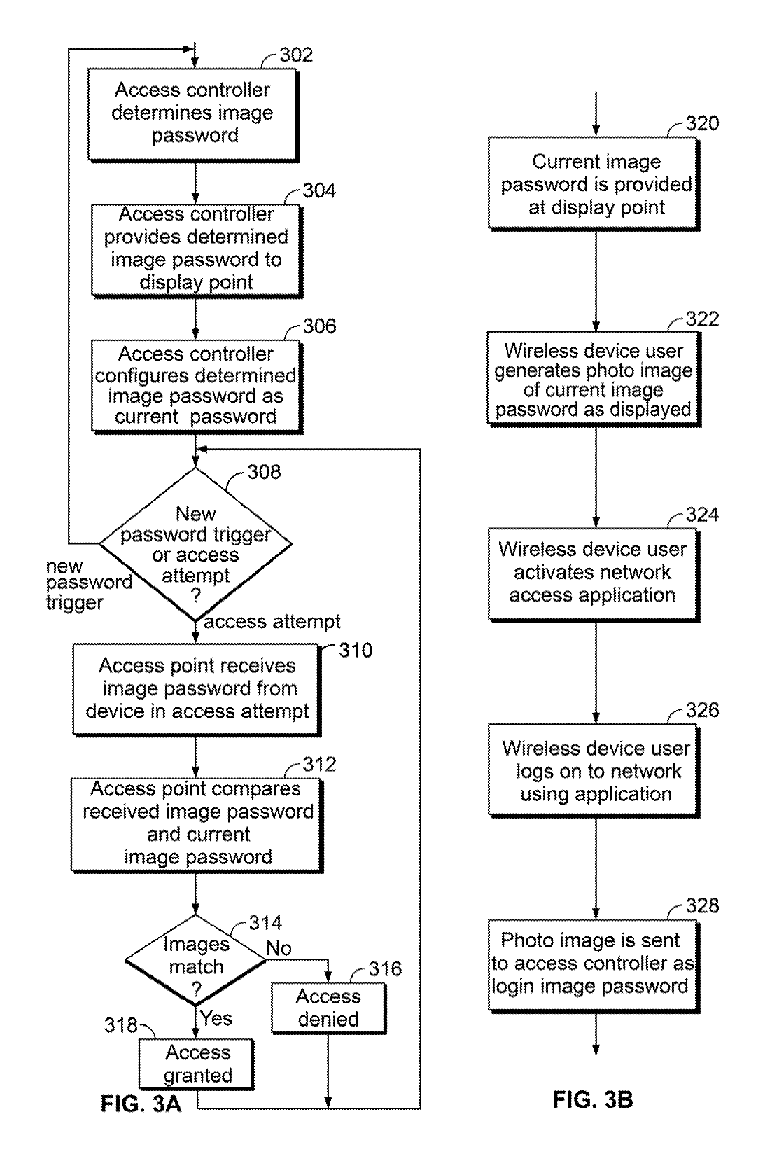

FIG. 3A is a flow diagram illustrating operations performed by an example access controller. FIG. 3A may explained using the example of access point 106 implemented as shown in FIG. 2 and used as shown in the example scenario of FIGS. 1A-1C.

The process begins at 302 where access controller 208 of access point 106 determines an image password to be used as the current password for WLAN 101 and configures the determined image password as the current image password. Access controller 208 may determine the current image password by controlling image password generator 202 to generate an image from image password database 204. In an example, image password database 204 may comprise a database including a set of a large number of images, and image password generator 202 may generate the image by randomly selecting an image from image password database 204. The images in image password database 204 may comprise photo images taken with a camera and input to access point 106 by manager 112, or any other type of images from a different source. Image password database 204 may be updated on a regular basis with one or more new images, or sets of images, from which image password generator 202 may select an image at 302. In another example, image password database 204 may include one or more images that are designated and selected as the image password for a particular time period. Image password database 204 may be configured to store the images in a format such as JPEG, TIFF, GIF, or any other image format that digitally encodes an image.

In another implementation, access controller 208 may receive information associated with an image password and determine the current image password at 302 from the received information. For example, access controller 208 may receive information that includes a photo image taken with a camera and input to access point 106 by manager 112, and determine the current image password from the received photo image. In another example, access controller 208 may receive information provided by manager 112 that includes a photo image and timing instructions indicating when the received photo image is to be used as the image password. In this case, access controller 208 may determine the image password at 302 from the received photo image and timing instructions.

At 304, access controller 208 provides the image password determined at 302 to a display point that comprises display monitor 108 through network interface 210 and server 102. The selected image password may then be stored in display monitor 108, and be available for display to visitors desiring access to WLAN 101 as shown in the example of FIG. 1B.

At 306, access controller 208 configures the current image password for WLAN 101 to be the image password determined at 302 by storing the image password determined at 302 in image password database 204 as the current image password. Wireless devices attempting to access WLAN 101 must now provide the image password determined at 302 in order to access WLAN 101. Access controller 208 may also start a timer running at 306. The timer may be set to expire at the end of a predetermined time period. The expiration of the timer may generate a new password trigger indicating that a new image password should be chosen. The time period may be any time period. For example, the timer may be set to expire in 24 hours.

At 308, access controller 208 monitors the timer started at 306 for a new password trigger indicating that it is time to select a new image password, while also monitoring for access attempts to WLAN 101 by wireless devices. When the monitoring at 308 detects a new password trigger, the process moves from 308 back to 302 and initiates selection of a new image password. When the monitoring at 308 determines that a wireless device has attempted to access WLAN 101, the process moves to 310.

At 310, access controller 208 of access point 106 receives an image password from wireless device 120 in an access attempt over wireless channel 122. In the example scenario of FIG. 1C, the image password received at 310 may comprise the photo image of the image password 118 on display monitor 108 that was taken by user 110 of wireless device 120 in FIG. 1B.

At 312, access controller 208 compares the image password received from wireless device 120 at 310 with the current image password stored in image password database 204 to determine if the received image password matches the current image password. Access controller 208 may control image analyzer 206 to use image analysis techniques to perform the comparison. The comparison at 312 may be performed using any appropriate image comparison/recognition techniques to determine if the received image password and the current image password match according to appropriate criteria. The criteria used to determine a match may be based upon a desired level of security. For example, for a high level of security, a high level of similarity between the received image password and current image password may be required for a match. For a low level of security, a lower level of similarity between the received image password and current image password may be required for a match than the level of similarity required for the high level of security.

In an example implementation the comparison at 312 may be performed by using a mean square error (MSE) determination. Access controller 208 may begin the determination by checking if the photo image comprising the received image password (image x) is the same size and same format as the image comprising the current image password (image y). If image x is not the same size and same format as image y, image x is resized and reformatted to the size and format of image y. In an alternative implementation, network application 214 on wireless device 120 may be configured to convert the photo image to the appropriate size and format before the photo image is sent to access controller 208. In this case, access controller 208 will not need to resize and reformat image x.

A mean square error (MSE) of the difference between image x and image y may next be calculated as:

MSE=∥image y−image x∥²

The MSE is then compared to a threshold value. If the MSE is less than the threshold value, the comparison is complete and the result of the comparison is determined to be that the received image password matches the current image password. The process then moves to 314. If, however, the MSE is greater than or equal to the threshold, a second MSE may be determined by shifting the pixels of image x relative to their original positions to generate image x (shifted), and calculating the MSE as:

MSE=∥image y−image x(shifted)∥²

The MSE determined from the shifted image x is then compared to the threshold. If MSE is less than the threshold, the comparison is complete and the result of the comparison is that the received image password matches the current image password. The process then moves to 314. If, however, MSE determined from image x (shifted) is greater than or equal to the threshold value, the pixels, of image x may be shifted a second time, and a third MSE may be determined with image x as shifted the second time. The determination of the MSE may be repeated based on successive shifts of the pixels of image x until the MSE is determined to be less than the threshold value, or until N repetitions of successively shifting image x and determining the MSE have been performed without MSE being less than the threshold. When the MSE is determined to be less than the threshold value during one of the repetitions, the result of the comparison at 312 is that the received image password matches the current image password and the process moves to 314. Alternately, when N repetitions have been performed without MSE being less than the threshold, the result of the comparison at 312 is that the received image password does not match the current image password, and the process moves to 314. In the implementation, the successive shifts of the pixels of image x may be alternated between the horizontal and vertical directions by shifting image x in a horizontal direction for one shift, and then shifting image x in a vertical direction for the next shift.

In another example implementation, the comparison at 312 may be performed by comparing the number of objects in the current image password and the number of objects in the received image password. Access controller 208 may control image analyzer 206 to determine the number of objects N1 in the current image password that meet selected criteria. For example, N1 may be the number of objects in the current image password that have a selected characteristic such as a particular shape. When access controller 208 receives an image password from wireless device 120, access controller 208 determines the number of objects N2 in the received image password that meet the same selected criteria as met by the N1 objects in the current image password. Access controller 208 may then determine if the received image password and current image password match based on a comparison of N1 and N2. The comparison of N1 and N2 may be performed in a manner that allows a match to be found between the received image password and the current image password, as long as any difference between N1 and N2 is within a plus/minus tolerance range.

At 314, access controller 208 determines if the comparison at 312 showed that the received image password matches the current image password stored in access controller 208. If the received image password and the current image password match, the process moves to 318. At 318, access controller 208 configures network interface 210 to allow wireless device 120 to access WLAN 101. If, however, at 314, it is determined that the received image password does not match the current image password stored in access controller 202, the process moves to 316. At 316, access controller 208 denies wireless device 120 access to WLAN 101. The process then returns to 308.

FIG. 3B is a flow diagram illustrating operations performed by an example device to access a wireless network. FIG. 3B may be used to explain the operation of wireless device 120 that is shown in FIG. 2 and in the example scenario of FIGS. 1A-1C.

The process begins at 320 where the current image password WLAN 101 is displayed at a display point. In the example scenario of FIG. 1B, the display at 320 may comprise a display of the current image password 118 on display monitor 108.

At 322, visitor 110 (wireless device user) provides input at user interface 212 that controls camera 218 of wireless device 120 to generate a photo image of the current image password 118. In the example scenario of FIG. 1B, visitor 110 generates the photo image by taking a photo image of the current image password 118 on display monitor 108. Manager 112 may instruct visitor 110 to take the photo image in an optimal way that provides a clear image for use as an image password. For example, visitor 110 may be instructed to fill at least a certain percentage of their viewfinder with the current image password 118, and hold the wireless device 120 so that the axis of the camera lens is as perpendicular to the display monitor 108 as possible. This may aid in the accuracy of the image processing used at access controller 208 to verify the image password.

At 324, visitor 110 activates network access application 214 through user interface 212 and, at 326, initiates logon to WLAN 101. Network access application 214 may lead visitor 110 through the logon using a series of prompts. For example, in the scenario of FIG. 1C, network access application 214 may prompt visitor 110 to select a photo image from a file containing camera images on wireless device 120 to use as the password. User 110 may select the photo image taken as the image password at 322, and the photo image is stored and configured in password image storage 216 by network application 214 as the image password to be used when accessing WLAN 101. If visitor 110 cancels the logon to WLAN 101 subsequent to the photo image being configured in network application 214, the stored image password may be used by network application 214 to access WLAN 101 until visitor 110 selects a new image password. Network access application 214 may also change the photo image to an appropriate format and size for use by access controller 208 of access point 106.

In another implementation of operations 322 and 324, network access application 214 maybe activated prior to the photo image being taken at 322. In this implementation, network access application 214 may lead visitor 110 through the process of taking the photo image and the logon using a series of prompts. When visitor 110 is taking the photo image, access application 214 may provide guidelines/instructions that are visible in the camera viewfinder and that aid visitor 110 in positioning monitor 108 and/or image password 118 in the camera viewfinder when taking the photo image. This may aid in obtaining a clear photo image that will allows accurate image password verification for network access at access point 106. When visitor 110 is finished taking the photo image, the photo image is stored in image password storage 216 by network application 214 as the image password to be used when accessing WLAN 101.

At 328, network access application 214 sends the photo image taken at 322 to access controller 208 of access point 106 as the image password for network logon/access. If access controller 208 validates the image password received from wireless device 120 as the current image password, wireless device 120 is granted access to WLAN 101. If access controller 208 does not validate the image password received for wireless device 120 as the current image password, wireless device 120 is denied access to WLAN 101.

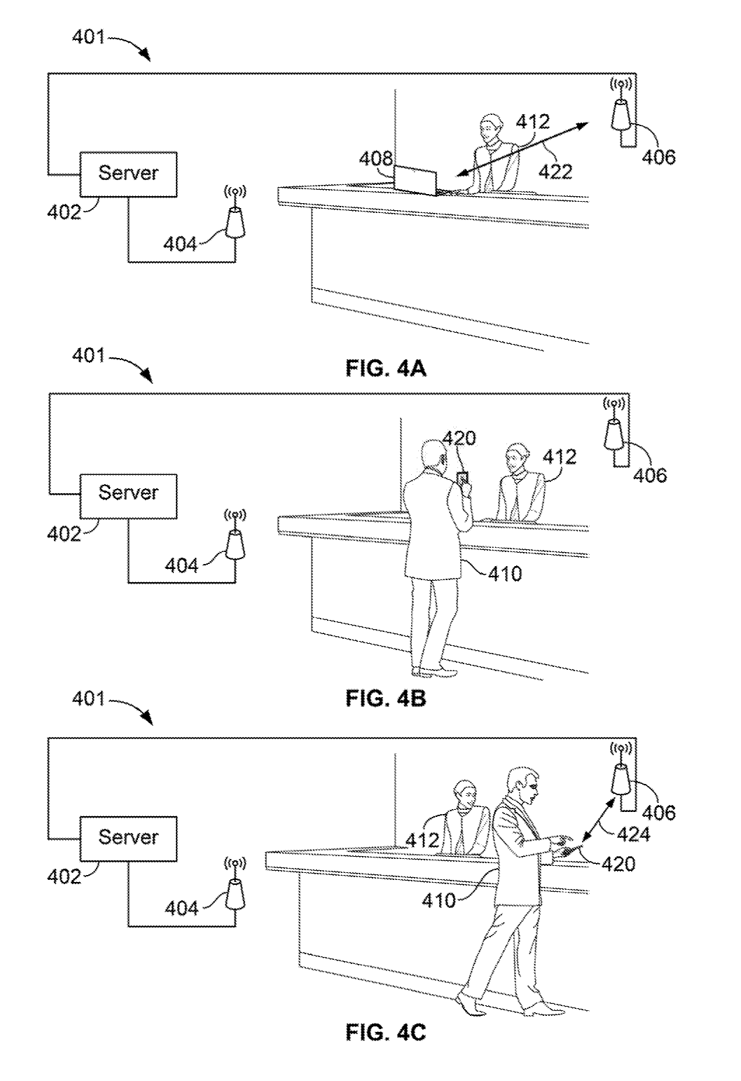

FIGS. 4A, 4B, and 4C illustrate scenario in which an apparatus according to another implementation of the disclosure is used to provide access to a WLAN. FIGS. 4A, 4B, and 4C, show the premises of an organization that operates an example WLAN 401 as a sequence of events take place over time. WLAN 401 may be implemented using server 402, access point 404, and access point 406. WLAN 401 may be a Wi-Fi network that operates similar to WLAN 101 shown in FIGS. 1A, 1B, and 1C. FIGS. 4A, 4B, and 4C also show computer device 408, which may comprise a laptop computer including a camera. Manager 412 may manage WLAN 401 to provide services to visitors, such as visitor 410 who uses wireless device 420 to access WLAN 401.

WLAN 401 may include an apparatus configured as an access controller that controls the infrastructure of WLAN 401 to allow visitors, such as visitor 410, to use image passwords to access WLAN 401. In an implementation, the access controller may be configured in access point 406. In this case, the access controller in access point 406 may provide network access to wireless devices attempting to access WLAN 401 through access point 406, and also include a function that communicates with access point 404 to provide network access to wireless devices attempting to access WLAN 401 through access point 404. In another implementation, the access controller may be implemented in server 402. In this case, server 402 may include functions that communicate with access point 404 and access point 406 to provide network access to wireless devices attempting to access WLAN 401.

FIGS. 4A, 4B, and 4C illustrate the process of accessing WLAN 401 at the visitor/manager level. At FIG. 4A, manager 412 is shown selecting an image password for WLAN 401. Manager 412 may use the camera of computer device 408 to take a photo image for use as the current image password. In the example of FIG. 4A, manager 412 is shown taking a photo of her own face as the photo image for use as the current image password. Manager 412 is then the subject of the current image password. When the photo image has been taken, manager 412 may control computer device 408 to send the photo image to access point 406 over Wi-Fi channel 422 for use by access point 406 as the current image password for WLAN 401.

Next, as shown in FIG. 4B, in order to allow visitor 410 to access WLAN 101, manager 412 may direct visitor 410 to take a photo image of the subject of the current image password, i.e., the face of manager 412, with the camera of wireless device 420.

Next, as shown in FIG. 4C, visitor 410 may use the photo image as the current image password to access WLAN 401 through access point 406. In an implementation, the photo image may be input as the image password directly to a logon interface at wireless device 420 provided by WLAN 401 and sent to access point 406. The access point 406 may then validate the photo image that was input at wireless device 420 using image analysis/processing to compare the photo image with the current image password. If the photo image and current image password match, the access point 406 may grant wireless device 420 access to WLAN 401.

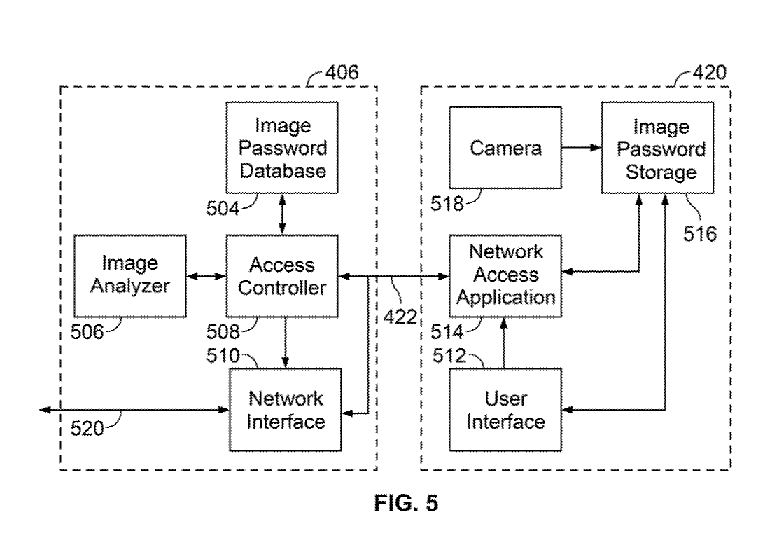

FIG. 5 is a diagram illustrating portions of an example access point and example device. Wireless device 420 of FIG. 5 represents an implementation of wireless device 420 FIGS. 4A-4C, and access point 406 of FIG. 5 represents an implementation of access point 406 of FIGS. 4A-4C. Access point 406 includes image analyzer 506, image password database 504, access controller 508, and network interface 510. Wireless device 420 includes camera 518, image password storage 516, user interface 512, and network access application 514. Access point 406 and wireless device 420 may communicate over Wi-Fi channel 422. Network interface 510 may connect access point 406 to server 402 through communication line 520. The portions of access point 406 and wireless device 420 that are shown in FIG. 5 may be implemented in hardware including processors and/or circuitry, in software, or in a combination of hardware and software.

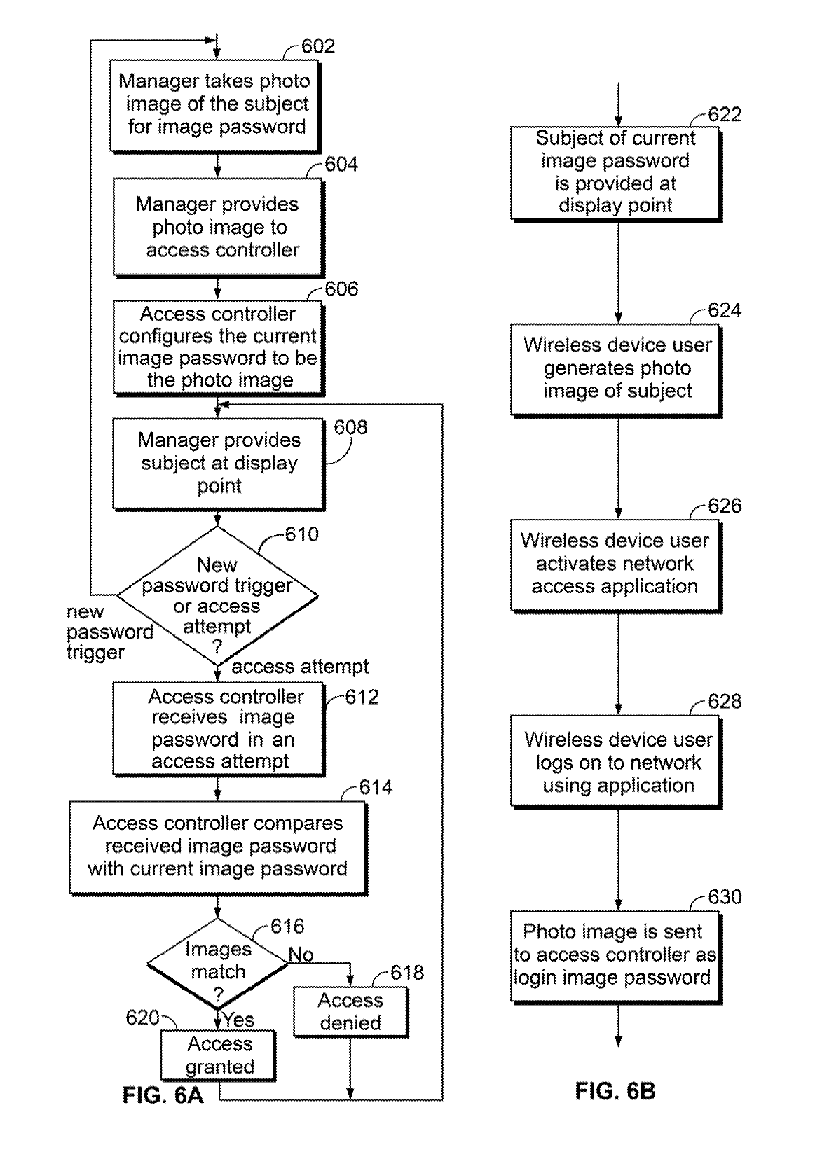

FIG. 6A is a flow diagram illustrating operations performed by an example access controller. FIG. 6A may be explained using the example of access point 406 implemented as shown in FIG. 5 and used as shown in the example scenario of FIGS. 4A-4C.

The process begins at 602 where manager 412 utilizes the camera of computer device 408 to take a photo image of a subject, where the photo image of the subject will be used as an image password for WLAN 101. In the example scenario of FIG. 4A, this is performed by manager 412 taking a photo image of her own face. In other examples, the subject of the photo image taken at 604 may be any subject that can be photographed. For example, the subject may be a physical object, a printed pattern, a scene, or any other object or group/set of multiple objects that may be recognized and analyzed in a photo image.

At 604, manager 412 provides the photo image taken at 602 to access controller 508 of access point 406 by controlling computer device 408 to send the photo image to access controller 508 over Wi-Fi channel 422. The operations at 602 and 604 may be performed using a password manager application on computer device 408. The password manager application may prompt and lead manager 412 through a password configuration process that allows manager 412 to select the photo image taken at 602 as the image password and send instructions to access point 406. The instructions may indicate that the photo image is to be used as the current image password for WLAN 401.

In another implementation of operations 602 and 604, the password manager application on computer device 408 may be activated prior to the photo image being taken at 602. In this implementation, the password manager application may lead manager 412 through the process of taking the photo image and the password configuration process using a series of prompts. When manager 412 is taking the photo image, password manager application may provide instructions and guide lines that are visible on the display of computer device 408. These instructions and sighting lines may aid visitor 510 in positioning the subject of the current image password in the viewfinder of the camera of computer device 408 when taking the photo image of the subject. This may aid in obtaining a clear photo image for the current image password that will allow accurate image password verification for network access at access point 106.

At 606, access controller 508 of access point 406 receives the photo image and instructions from computer device 408. Base on the received instructions, access controller 508 configures the current image password for network access to be the photo image by storing the photo image in image password database 504 as the current image password. Access controller 508 may also start a timer running at 606, where the expiration of the timer will generate a new password trigger indicating that a new image password should be chosen for WLAN 401.

At 608, the subject of the photo image that has been used to configure the current image password is made available at a display point. Visitors desiring access to WLAN 401 may now take a photo image of the subject and use the photo image as an image password to access WLAN 401. In the example scenario of FIG. 4B, the subject is made available by making manager 412 accessible at the service counter so that visitor 410 may take a photo image of the face of manager 412 to use as the image password. In other examples, the display of the subject of the photo image may be any type of display/presentation that allows the visitor to take a photo image of the subject of the current image password.

At 610, access controller 508 monitors the timer started at 606 for the new password trigger indicating that the timer has expired and that it is time to select a new image password. Also, at 610, access controller 508 monitors for access attempts to WLAN 401 by wireless devices. When the monitoring at 610 for the new password trigger indicates that the timer has expired and that it is time to select a new image password, the process moves from 610 back to 602 and initiates selection of a new password. If, however, a wireless device attempts to access WLAN 401 during the monitoring at 610 the process moves to 612.

At 612, access controller 508 of access point 406 receives an image password from wireless device 420 in an access attempt. The received image password may be sent to access controller 508 over wireless channel 422. In the example scenario of the access attempt of FIG. 4C, the received image password may comprise the photo image taken of manager 412 by visitor 410 in FIG. 4B.

At 614, access controller 508 of access point 406 compares the received image password with the current image password stored in image password database 504. Access controller 508 may control image analyzer 506 to use image analysis techniques to perform the comparison. The comparison at 614 may be performed as was described for operation 312 of FIG. 3A.

At 616, access controller 508 determines if the comparison at 614 showed that the received image password matches the current image password stored in access controller 508. If the received image password and the current image password match, the process moves to 620. At 620, access controller 508 configures network interface 510 to allow wireless device 420 to access WLAN 401. If, however, at 616, it is determined that the image password received from wireless device 420 does not match the current image password stored in access controller 508, the process moves to 618. At 618, access controller 508 denies wireless device 420 access to WLAN 401. The process then returns to 608, where access controller 508 monitors the timer and waits to receive an image password in another access attempt.

FIG. 6B is a flow diagram illustrating operations performed by example device to access a wireless network. FIG. 6B may be used to explain the operation of wireless device 420 that is shown in FIG. 5 and in the example scenario of FIGS. 4A-4C.

The process begins at 622 where the subject of the current image password is provided at a display point in a display comprising a physical presentation of the subject of the current image password. In the example scenario of FIG. 4B, this is done when manager 412 makes her face visible to visitor 410 at a display point behind the service desk so that visitor 110 may take a photo image of the face of manager 412 as the subject of the image password

At 624, visitor 410 (wireless device user) controls camera 518 of wireless device 420 at user interface 512 to generate a photo image of the subject of the current image password. In the example scenario of FIG. 4B, visitor 110 generates the photo image by taking a photo image of the face of employee 412. When directing visitor 410 to take the photo image, manager 412 may instruct visitor 410 so that the photo image is taken in an optimal way that provides a clear image for use as an image password. For example, visitor 410 may be instructed to fill at least a certain percentage of their viewfinder with the subject of the current image password, and hold the wireless device 420 so that the axis of the camera lens is as perpendicular to the face of manager 412 as possible. This may aid in the accuracy of the image processing used to verify the image password at access point 406 in a network access attempt.

At 626, visitor 410 activates network access application 514 through user interface 512 and, at 628, initiates logon to WLAN 401. Network access application 514 may lead visitor 410 through the logon using a series of prompts. For example, in the scenario of FIG. 4C, network access application 514 may prompt visitor 410 to select a photo image from a file containing camera images on wireless device 420 to use as the password. User 410 may select the photo image taken as the image password at 624, and the photo image is stored and configured in password image storage 516 by network application 514 as the image password to be used when accessing WLAN 401. If visitor 510 cancels the logon to WLAN 401 subsequent to the photo image configured in network application 514, the stored image password may be used by network application 514 to access WLAN 401 until visitor 410 selects a new image password.

In another implementation of operations 624 and 626, network access application 514 may be activated prior to the photo image being taken at 624. In this implementation, network access application 514 may lead visitor 510 through the process of taking the photo image and the logon using a series of prompts. When visitor 510 is taking the photo image, network access application 514 may provide instructions and sighting lines that are visible in the camera viewfinder and aid visitor 510 in positioning the subject of the current image password in the camera viewfinder. This may aid in obtaining a clear photo image that will allow accurate image password verification for network access at access point 406. When visitor 510 is finished taking the photo image, the photo image is stored and configured in image password storage 516 by network application 514 as the image password to be used when accessing WLAN 401.

At 630, the photo image taken at 624 is sent to access controller 508 of access point 406 as the logon image password. If access controller 508 validates the image password received for wireless device 420 as the current image password, wireless device 420 is granted access to WLAN 401.

In other implementations, the function of FIGS. 2 and 5 that are described as being implemented in the access points 106 and 406, respectively, of a wireless network may be implemented in a server, such as server 102 or 402. In this case, the server would receive an image password from the wireless device through an access point during an access attempt, and grant access to the wireless device if the received image password matches the current image password.

In a further implementation, the function of FIGS. 2 and 5 that are described as being implemented in the access points 106 and 406, respectively, may be implemented in a wireless device, such as wireless device 120 or 420.

When implemented on a wireless device, the application may be an application installed/provided for use on the wireless device by the organization that manages the WLAN. The application may include an access controller that is configured to communicate with a server managed by the organization. The application maybe a trusted application configured to provide secure communications with the server. Use of the application on the wireless device may serve to confirm that a visitor (user of the wireless device) desiring to use the WLAN is located on the organizations premises by requiring the visitor to enter an image password comprising a photo image taken on the premises.

In operation, a visitor desiring to access a WLAN may activate the application on their wireless device. When the application is activated, the access controller may determine a current image password from an image password stored in memory or retrieved from the server over a secure connection by the application. The visitor may then be directed by a network manager to use the camera of the wireless device to take a photo image of a display associated with the current image password. The application may generate an image password from the photo image, and provide the generated image password to the access controller. The access controller may receive the generated image password and determine if the generated image password and the current image password match. If the photo image and the current image password match, the access controller of the application may allow a user to access the wireless network through the secure application.

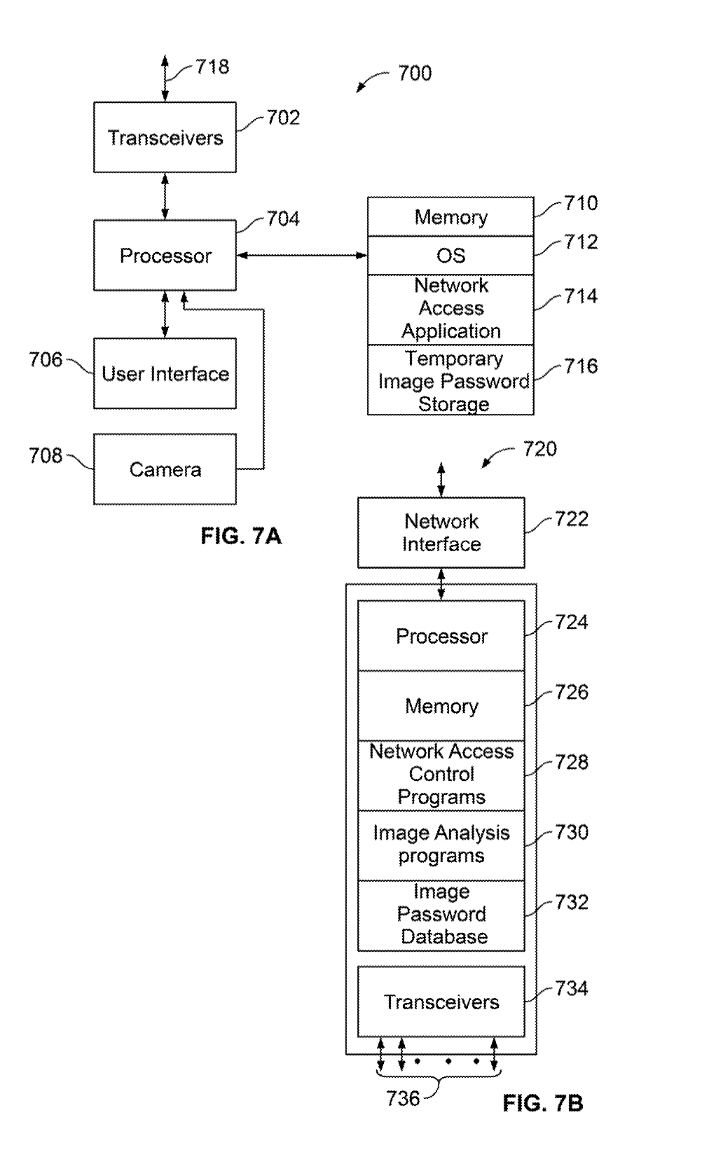

FIG. 7A is a simplified block diagram showing an example device. Wireless device 700 represents an example implementation of wireless devices 120 and 420 that were described in relation to FIGS. 2 and 5, respectively.

Wireless device 700 includes processor 704 that is coupled to transceivers 702, user interface 706, camera 708, and memory 710. Memory 710 includes code and program/instructions for operating system (OS) 712, network access application 714, and image password storage 716. Wireless device 700 may communicate with an access point of a network over one or more wireless channels 718 using transceivers 702. In an example implementation, wireless device 700 may be any type of wireless device that is configured to operate according to one or more of the IEEE 802.11 Wi-Fi wireless standards. In other implementations, wireless device 700 may be any type of wireless device configured to operate according to any other appropriate wireless standard or proprietary wireless configuration.

Processor 704 may comprise one or more processors, or other control circuitry or any combination of processors and control circuitry that provide overall control of wireless device 700 according to the disclosed embodiments. Memory 710 may be implemented as any type of as any type of computer readable storage media, including non-volatile and volatile memory. In an implementation, execution of network access application 714 causes processor 704 to implement operations that cause wireless device 700 to operate according to the operations described in relation to FIGS. 3B and 5B.

FIG. 7B is a simplified block diagram showing an example access point 720. Access point 720 represents an example implementation of access points 106 and 406 that were described in relation to FIGS. 2 and 5, respectively.

Access point 720 includes processor 724 that is coupled to network interface 722, transceivers 734, and memory 726. Memory 726 includes code and program/instructions for network access control programs 728, image analysis programs 730, and image password database 732.

Access point 720 may communicate with wireless devices over one or more wireless channels 736 using transceivers 734. In an example implementation, access point 720 may be configured to operate according to one or more of the IEEE 802.11 Wi-Fi wireless standards. In other implementations, access point 720 may be configured to operate according to any other appropriate wireless standard or proprietary wireless configuration.

Processor 724 may comprise one or more processors, or other control circuitry or any combination of processors and control circuitry that provide overall control of wireless device 700 according to the disclosed embodiments. Memory 726 may be implemented as any type of as any type of computer readable storage media, including non-volatile and volatile memory. In an implementation, execution of network access control programs 728 and image analysis programs 730 causes processor 724 to implement operations that cause access point 720 to operate according to the operations described in relation to FIGS. 3A and 5A.

The example embodiments disclosed herein may be described in the general context of processor-executable code or instructions stored on memory that may comprise one or more computer readable storage media (e.g., tangible non-transitory computer-readable storage media such as memory 710 or 726). As should be readily understood, the terms “computer-readable storage media” or “non-transitory computer-readable media” include the media for storing of data, code and program instructions, such as memory 710 or 726, and do not include portions of the media for storing transitory propagated or modulated data communication multi-carrier signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed implementations include an apparatus for controlling access to a network. the apparatus comprises one or more processors and memory coupled to one or more processors, the memory comprising code that is executable by the one or more processors to control the apparatus to configure a first image password for the network, receive a second image password, the second image password generated at a device, determine if the first image password and the second image password match, and, if the first image password and the second image password match, grant the device access to the network. The first image password may comprise a first photo image of at least one subject and the second image password may comprise a second photo image the at least one subject. The code further may be further executable by the one or more processors to control the apparatus to receive the first photo image of the at least one subject, and configure the first photo image of the at least one subject as the first image password. The code may be further executable by the one or more processors to control the apparatus to provide the first image password to a display device, and the second image password may comprise a photo image of the first image password displayed on the display device. The code may be further executable by the one or more processors to control the apparatus to receive information associated with the first image password, and, configure the first image password based on the received information. The wherein the code may be further executable by the one or more processors to control the apparatus to generate the first image password from a database of images. The code may be further executable by the one or more processors to control the apparatus to randomly generate the first image password from the database of images. The apparatus may be implemented in an access point. The apparatus may be implemented in a server. The apparatus may be implemented in the device.

The disclosed implementations also include a method for controlling access of a device to a network. The method comprises configuring a first image password for the network, providing a display associated with the first image password, receiving a second image password, the second image password comprising a photo image of the display taken with a camera of the device, determining if the first image password and the second image password match, and, if the first image password and the second image password match, granting the device access to the network. The providing the display associated with the first image password may comprise providing a physical display of at least one subject of the first image password, and the photo image of the display may comprise a photo image of the at least one subject. The photo image of the display may comprise a first photo image, and the method may further comprise receiving a second photo image of the at least one subject, and configuring the second photo image of the at least one subject as the first image password. The providing the display associated with the first image password may comprise displaying the first image password on a display device, and the second image password may comprises a photo image of the first image password displayed on the display device. The method may further comprise receiving information that is associated with the first image password and configuring the first image password based on the information. The information may include information indicating a time for use of the first image password. The method may further comprise generating the first image password at an access controller. The first image password may be randomly generated from an image password database. The configuring the first image password and the providing the display associated with the first image password may be repeated on predetermined basis.

The disclosed implementations may further include a system for controlling access to a network, the system comprising a display device and an apparatus coupled to the display device. The apparatus may comprise one or more processors and memory coupled to the one or more processors. The memory may comprise code that is executable by the one or more processors to control the apparatus to configure a first image password for the network, provide a display of the first image password at the display device, receive a second image password from a device, the second image password including a photo image of the display of the first image password, determine if the first image password and the second image password match, and, if the first image password and the second image password match, grant the device access to the network.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus for controlling access to a network, the apparatus comprising:
one or more processors; and,
memory coupled to the one or more processors, the memory comprising code that is executable by the one or more processors to control the apparatus to:
configure a first image password for the network;
receive a second image password, the second image password generated at a device;
determine if the first image password and the second image password match;
and, if the first image password and the second image password match, grant the device access to the network.

2. The apparatus of claim 1, wherein the first image password comprises a first photo image of at least one subject and the second photo image, comprises a second photo image of the at least one subject.

3. The apparatus of claim 2, wherein the code further is further executable by the one or more processors to control the apparatus to receive the first photo image of the at least one subject, and configure the first photo image of the at least one subject as the first image password.

4. The apparatus of claim 1, wherein the code is further executable by the one or more processors to control the apparatus to provide the first image password to a display device, and the second image password comprises a photo image of the first image password displayed on the display device.

5. The apparatus of claim 1, wherein the code is further executable by the one or more processors to control the apparatus to receive, information associated with the first image password and configure the first image password based on the received information.

6. The apparatus of claim 1, wherein the code is further executable by the one or more processors to control the apparatus to generate the first image password from a database of images.

7. The apparatus of claim 6, wherein the code is further executable by the one or more processors to control the apparatus to randomly generate the first image password from the database of images.

8. The apparatus of claim 1, wherein the apparatus is implemented in an access point.

9. The apparatus of claim 1, wherein the apparatus is implemented in a server.

10. The apparatus of claim 1, wherein the apparatus is implemented in the device.

11. A method for controlling access of a device to a network, the method comprising:
configuring a first image password for the network;
providing a display associated with the first image password;
receiving a second image password, the second image password comprising a photo image of the display taken with a camera of the device;
determining if the first image password and the second image password match; and,
if the first image password and the second image password match, granting the device access to the network.

12. The method of claim 11, wherein the display is a physical display of at least one subject of the first image password, and the photo image of the display comprises a photo image of the at least one subject.

13. The method of claim 12, wherein the photo image of the display comprises a first photo image, and the method further comprises receiving a second photo image of the at least one subject, and configuring the second photo image of the at least one subject as the first image password.

14. The method of claim 11, wherein providing the display associated with the first image password comprises displaying the first image password on a display device, and the second image password comprises a photo image of the first image password displayed on the display device.

15. The method of claim 11, wherein the method further comprises receiving information that is associated with the first image password and configuring the first image password based on the information.

16. The method of claim 15, wherein the information indicates a time for use of the first image password.

17. The method of claim 11, wherein the method further comprises generating the first image password at an access controller.

18. The method of claim 17, wherein the first image password is randomly generated from an image password database.

19. The method of claim 11, wherein configuring the first image password and providing the display associated with the first image password are repeated on a predetermined basis.

20. A system for controlling access to a network, the system comprising:
a display device; and,
an apparatus coupled to the display device, the apparatus comprising one or more processors and memory coupled to the one or more processors, the memory comprising code that is executable by the one or more processors to control the apparatus to:
configure a first image password for the network;
provide a display of the first image password at the display device;
receive a second image password from a device, the second image password including a photo image of the display of the first image password;
determine if the first image password and the second image password match; and,
if the first image password and the second image password match, grant the device access to the network.
